(19) United States
(12) Patent Application Publication
(10) Pub. No.: US 2024/0351882 A1
(43) Pub. Date: Oct. 24, 2024

(54) Production of Graphene

(71) Applicant: ALPHA ASSEMBLY SOLUTIONS INC., Waterbury, CT (US)

(72) Inventors: Nirmalya Kumar CHAKI, Karnataka (IN); Barun DAS, Karnataka (IN); Supriya DEVARAJAN, Karnataka (IN); Siuli SARKAR, Karnataka (IN); Rahul RAUT, Sayreville, NJ (US); Bawa SINGH, Marlton, NJ (US); Ranjit PANDHER, Plainsboro, NJ (US); Oscar KHASELEV, Monmouth Junction, NJ (US)

(21) Appl. No.: 18/664,412

(22) Filed: May 15, 2024

Related U.S. Application Data
(63) Continuation of application No. 15/265,385, filed on Sep. 14, 2016, now abandoned.

(51) Int. Cl. C01B 32/19; C25B 1/00; C25B 9/00

(52) U.S. Cl. CPC C01B 32/19; C25B 1/00; C25B 9/00

(57) ABSTRACT

A method of synthesizing high quality graphene for producing graphene particles and flakes is presented. The engineered qualities of the graphene include size, aspect ratio, edge definition, surface functionalization and controlling the number of layers. Fewer defects are found in the end graphene product in comparison to previous methods. The inventive method of producing graphene is less aggressive, lower cost and more environmentally friendly than previous methods. This method is applicable to both laboratory scale and high volume manufacturing for producing high quality graphene flakes.

### FIELD OF THE INVENTION

The present invention relates generally to a method of producing high quality graphene. The method is particularly suitable for producing engineered graphene particles and flakes.

### BACKGROUND OF THE INVENTION

Graphene is one of the most exciting materials being investigated not only due to intense academic interest but also with potential applications in mind. Graphene is the “mother” of all graphite forms; including 0-D: bucky balls, 1-D: carbon nanotubes and 3-D: graphite. Electronic and Raman spectra of carbon nanotubes and graphene differ significantly, even though carbon nanotubes are formed through the rolling of graphene sheets. Graphene exhibits significantly different physical properties than that of carbon nanotubes, such as electrical conductivity, thermal conductivity and mechanical strength. Graphene has fascinating properties, such as anomalous quantum Hall effect at room temperature, an ambipolar electric field effect along with ballistic conduction of charge carriers, tunable band gap, and high elasticity. The lack of a suitable environmentally innocuous, high volume or “bulk” manufacturing method for the production of high-quality graphene restricts graphene for use in commercial applications.

Conventionally, graphene is defined, is a single layer two-dimensional material, but bi-layer graphene, with more than two but less than ten layers, is also considered “few layer graphene” (FLG). FLG is often visualized as 2D stacking of graphite layers, which start to behave like graphite if there are more than ten layers. Most investigations of physical properties of graphene are performed using mono-layer pristine graphene obtained either by micro-mechanical cleavage or by chemical vapor deposition (CVD). However, producing bulk quantities of graphene using these methods is still a challenging task.

Several non-limiting applications of graphene, include being an active ingredient in polymer composites, interconnect applications, transparent conductors, energy harvesting and storage applications. Non-limiting examples of such applications include batteries, supercapacitors, solar-cells, sensors, electrocatalysts, electron field emission electrodes, transistors, artificial muscles, electroluminescence electrodes, solid-phase microextraction materials, water purification adsorbents, organic photovoltaic components and electromechanical actuators.

One of the widely used methods for the bulk production of graphene type materials is known as “Hummer's” or “Modified Hummer's” method. This process generates heavily hydrophilic functionalized graphene materials, known as graphene oxide. Hummer's method relies on the use of aggressive oxidative steps to achieve exfoliation of graphite powder. The resulting flakes are either highly defective graphene or graphene oxide, which needs to be further processed to produce graphene from graphene oxide. Graphene oxide is an electrically insulating material, unlike graphene which is electrically conductive. Graphene oxide is not suitable for a vast majority of applications. Typically, thermal or chemical reduction is necessary to restore, at least in part, the x-electrons of graphene from highly insulating phase graphene oxide. An additional limitation and negative side effect of employing the Hummer's method is that the method results in very large quantity of acidic waste.

There have been efforts over the past few years to develop an environmentally safe, scalable synthetic method for the bulk-production of high-quality graphene. Methods include solvent-and/or surfactant-assisted liquid-phase exfoliation, electrochemical expansion, and formation of graphite intercalated compounds. The electrochemical exfoliation method of graphite sheet/block production has shown significant promises in the scientific community because it is an easy, quick, and environmentally benign manner of bulk producing of high-quality graphene.

There are two kinds of well-known electrochemical exfoliation processes, “anodic” and “cathodic”. The anodic process seems to be the most efficient in terms of yield of the final product, but creates substantial amount of defects/functionalization of the resulting graphene material during the course of the exfoliation process. On the other hand, a cathodic process results in much higher quality graphene material, but the yield needs to be significantly improved for high volume manufacturing.

In the anodic process, highly pure graphite sheets/blocks/rods are used as the working electrode (anode) and metals or conductors are used as counter cathode (cathode) (FIG. 14). The anodic process takes place in various media e.g. ionic liquids. aqueous acids (e.g., H₂SO₄ or H₃PO₄); or in an aqueous media containing a suitable exfoliating ion, such as SO₄²⁻ or NO₃⁻. During the aqueous anodic electrochemical exfoliation process, molecular O₂ evolves at the anode and creates defects on the resulting graphene flakes. The defects that affect the quality of graphene materials in turn affect the quality of the final target application. In the anodic process, the diameter of SO₄²⁻ exfoliation ion is compatible with the interlayer spacing between the graphite layers, which results in more efficient exfoliating.

In a cathodic process, highly pure graphite sheet/block/rod is used as the working electrode (cathode) and metals or other conductors are used as a counter electrode (anode) (FIG. 14). This process is carried out in various media such as LiClO₄ in propylene carbonate electrolyte, triethylammonium and Li ions in a DMSO-based electrolyte, or in a mixture of molten salt, such as LiOH or LiCl in DMSO, NMP or a mixture thereof. Other salts and mixture combinations can also be used. A molten salt mixture having a molar ratio of 1:2:1 of KCl, LiCl, Et₃NH⁺Cl⁻ respectively in DMSO is taught by Dryfe et. al. US Pub No. 2015/0027900 A1, which is hereby incorporated by reference in its entirety. Tri/tetra alkyl ammonium containing ions in DMSO, NMP or in a mixture thereof, is an efficient electrolyte for graphene production.

The electrochemical exfoliation process is divided into two steps: first there is intercalation of suitable ions between the graphite inter-layers through electrostatic interactions and then a second step that generates various gases and leads to production of few-layered graphene flakes from swelled/expanded bulk graphite under electrochemical biasing conditions. There is a need to improve this method so that the process is more environmentally friendly while producing high yields, which can be suitable for large scale manufacturing.

### SUMMARY OF THE INVENTION

It is therefore an object of the current invention to provide an improved method for electrochemical graphene production.

It is an object of the current invention to provide higher quality graphene, with fewer defects than previous methods.

It is another object of the current invention to enable engineered graphene products,

It is another object of the current invention to provide an environmentally benign method of producing graphene.

It is yet another object of the current invention to provide less effluent in the graphene production method.

It is yet a further object of the current invention to provide non-hazardous effluent, consumables, and chemicals in the electrochemical graphene production method.

It is another object of the current invention to allow for scalability and high volume manufacturing capability.

It is yet another object of the current invention to allow for process monitoring, automation and continuous production of high quality graphene.

It is yet another object of the current invention to provide a low cost method of producing high quality graphene.

It is yet a further object of the current invention to provide a method of tailoring the dimensions of high quality graphene.

To that end, in one embodiment, the present invention relates generally to a method of making high quality graphene comprising the steps of:
a. providing an electrochemical cell, wherein the electrochemical cell comprises:
   i. one or more working electrodes;
   ii. one or more counter electrodes; and
   iii. an aqueous electrolyte comprising one or more exfoliating ions;
b. exfoliating the working electrode to produce high quality graphene;
   wherein the high quality graphene has characteristics that are engineered for targeted applications.

In another preferred embodiment, the present invention relates generally to an electrochemical cell for making graphene flakes comprising:
a. a graphene producing working electrode;
b. a counter electrode; and
c. an aqueous electrolyte comprising one or more exfoliating ions;
   wherein high volume and high quality graphene is produced.

### BRIEF DESCRIPTION OF THE DRAWINGS

FIG. 1 shows comparative powder X-ray diffraction (PXRD) patterns (X-axis: 2θ & Y-axis: Intensity) of examples 1-9.

FIG. 2 shows comparative Raman spectra (X-axis: Raman shift & Y-axis: Intensity) of examples 1-9. All Raman spectra were recorded with 633 nm He—Ne laser.

FIG. 3 shows comparative thermogravimetric analysis (TGA) curves in air of examples 1-9.

FIG. 4 shows field emission scanning electron microscope (FESEM) images of examples 1-3 and 5-9. Flake morphology was evident from all these images.

FIG. 5 shows comparative TGA curves in air of examples 6 and 10-12.

FIG. 6 shows comparative Raman spectra (X-axis: Raman shift & Y-axis: Intensity) of examples 6 and 10-12. All the Raman spectra were recorded with 633 nm He—Ne laser.

FIG. 7 shows comparative TGA curves in air of example 5, 6, 8, 9, 16 and 17.

FIG. 8 shows comparative TGA curves in air of example 6, 18 and 19.

FIG. 9 shows comparative Raman spectra (X-axis: Raman shift & Y-axis: Intensity) of examples 6, 18 and 19. All the Raman spectra were recorded with 633 nm He—Ne laser.

FIG. 10 shows comparative Raman spectra (X-axis: Raman shift & Y-axis: Intensity) of example 5, 20 and 21. All the Raman spectra were recorded with 633 nm He—Ne laser.

FIG. 11 shows comparative PXRD patterns (X-axis: 2θ & Y-axis: Intensity) of examples 5 and 21.

FIG. 12 shows comparative TGA curves in air of examples 5, 20 and 21.

FIG. 13 shows comparative TGA curves in air of examples 5 and 22 and characteristic Raman spectrum of example 22.

FIG. 14 shows representative electrochemical set-up used for examples 5, 6, 8 and 9.

FIG. 15A depicts a plausible mechanistic pathway to produce graphene flakes using one exfoliating ion. FIG. 15B depicts a plausible mechanistic pathway to produce much thinner

FIG. 16 shows different arrangements of electrodes (anode and cathode) during the exfoliation process namely parallel (A), co-axial (B) and alternate comb (C) fashion.

### DETAILED DESCRIPTION OF THE PREFERRED EMBODIMENTS

The present invention discloses a simple, environmentally benign, scalable production method involving electrochemical exfoliation (both anodic as well as cathodic) of graphite. High quality graphene materials can be produced with multiple exfoliating ions which enables engineering of end flakes for targeted applications. The characteristics that can be engineered include size, aspect ratio, edge definition, surface functionalization and number of layers.

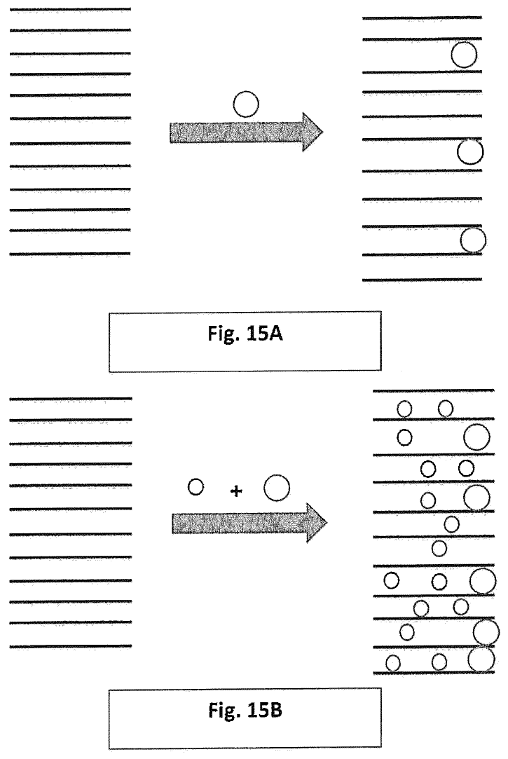

In this invention, a combination of exfoliating ions is used, which enables greater control in both kinetics and tailoring the features of graphene materials (FIGS. 15A and 15B). For example, utilization of a mixture of ions of various sizes will generate a situation such that smaller ions will facilitate the exfoliation of larger ions more efficiently. This will enable the control of the dimensions of graphene as well as the yield of the entire process.

All the previous methods have generally focused on a single species of exfoliating ions. This approach of using multiple exfoliating ions enables engineering of end graphene flakes for targeted applications. A particular strength of this method is its benign nature leading to fewer defects in the end product. This is due to use of less corrosive/aggressive reaction media,

In comparison, a widely used process, namely the Hummer's method relies on use of aggressive oxidative steps to achieve exfoliation. The resulting flakes are either highly defective graphene or graphene oxide, which needs to be further processed to produce graphene from graphene oxide. Further, Hummer's method produces much smaller flakes than the method presented herein. Another major limitation, and often a stumbling block, of the Hummer's method is the resulting very large quantity of acidic waste. A major advantage of the present method is that it does not use acid. Furthermore, much smaller quantities of reaction media are employed in the current invention.

The present method results in much larger graphene flakes with far fewer defects and far less oxidation compared to previous methods.

Another key benefit of the present invention is that it can be continuous and amenable to automation. This feature enables subsequent processing steps to be added, thereby enabling the production of engineered particles ready for targeted end applications.

A key feature of this approach is to generate the exfoliating ions through use of appropriate salts in aqueous media. The current invention results in a gentler (less aggressive) media. It is an electrochemical process that can be implemented at ambient temperature. These features result in an overall low cost and a greener process.

The method has remarkable advantages over other methods described in prior art that use, for example, ionic liquids, acidic media, and molten metal salts. The present method can be implemented either in aqueous media or acid media or a combination thereof.

A second key feature of the inventive approach is the use of multiple exfoliating ions in the same process. Prior described methods have generally focused on a single species of exfoliating ions. This method of using multiple exfoliating ions enables engineering of end flakes for targeted applications. In using this method, it enables use exfoliating ions of different sizes in order to control the graphene flake dimensions (Thickness, Lateral Dimensions) as well as the kinetics of the exfoliation process. The results of using a combination of exfoliating ions were both surprising and unexpected.

A third key feature of the current method is to vary the ratio of the exfoliating ions mixture. This enables control the kinetics of the exfoliating process.

A fourth key feature of our approach is the possibility of changing the polarity as a part of the process to engineer a particular or a set of properties. This feature provides substantial flexibility to the overall process.

Another key feature of this method is that the duty cycle can be varied for the electrochemical process. This is another key to optimizing the method as well as being able to engineer attributes and properties of the graphene particles and flakes for targeted applications.

In the case where both electrodes are fabricated from carbon materials, the electrical potentials can be applied in pulse mode by alternately changing the polarity of the electrodes from positive to negative or vice versa. The duty cycle (changes the electrodes polarity) can be selected or optimized for a particular solvent and electrolyte mixture. Furthermore, this configuration of both carbon electrodes can be used in static mode, where the polarity is fixed and not changed. Anode-cathode pairs can be configured as an independent circuit, or be connected in series, or in parallel configurations.

However, it is emphasized that the use of multiple exfoliating ions, ratios of these ion mixtures and flexible duty cycles and changes in polarity may also be beneficially employed in other approaches that use molten liquid salts, acids and solvent media. This method is particularly well suited for the use of flexible, multiple steps to further enhance or improve the graphene particles and flakes for targeted end applications

The electrochemical cell for producing graphene flakes includes a graphene producing working electrode and another electrode, called counter electrode, which is an inert electrode that is stable in the electrolyte containing solvent.

The electrochemical cell for high volume manufacturing can be fitted with multiple working and counter electrodes and can be connected in series or in parallel fashion. Furthermore, this multiplicity of cathode-anode configurations can be independent circuits. Additionally counter electrode or working electrode positions can be parallel, coaxial or in alternating comb fashion.

The electrochemical device that supplies electrical potential either in static (solely positive or solely negative), potential sweep, or pulse mode that is alternately changing the polarity of electrodes from positive to negative, or vice versa after a fixed duty cycle.

The electrochemical cell is additionally fitted with an external cooling/heating jacket for cooling or heating solvents. Furthermore some other heating device can be employed, such as hot plate or microwave system to achieve the same effect (heating or cooling).

The working electrode that is used to produce graphene flake or particles is manufactured from pyrolytic graphite, natural graphite, synthetic graphite, intercalated carbon materials, carbon fiber, carbon flakes, carbon platelets, carbon particles or used processed or manufactured graphite sheets. Furthermore, the working electrode can be produced from carbon powder or flakes compressed together to form sheets, rods or pellets etc.

The counter electrode is an inert conducting metallic or nonmetallic electrode that is stable in the electrolyte containing solvent. The counter electrodes can be made from, metals such as platinum, titanium, high quality steel, aluminum, or from a nonmetal conductor, such as graphite or glassy carbon, etc.

This method is particularly well suited for the use of flexible, multiple steps to further enhance or improve the graphene particles and flakes for targeted end applications using a preprocessed graphite or carbon electrodes. The electrode may be chemically pretreated by electrochemical treatment, thermal treatment, sonication treatment, or by plasma treatment in a suitable choices of solvents/electrolytes/acids/bases and inorganic compounds or in air or in vacuum.

For a separate cell design, an electrochemical graphene producing configuration can be used, where both electrodes are carbon based. Both of these working and counter electrodes can be fabricated from any number of carbon materials. Examples of suitable carbon materials are carbon or graphite based materials, such as pyrolytic graphite, natural graphite, synthetic graphite, intercalated carbon materials, carbon fiber, carbon flakes, carbon platelets, carbon particles, or manufactured graphite sheets. Furthermore, the working electrode can be produced from carbon powder or flakes compressed together to form sheet, rods or pellets etc.

In the case where both electrodes are fabricated from carbon materials, the electrical potentials can be applied in a pulse mode that is alternately changing the polarity of the electrodes from positive to negative or vice versa. The duty cycle (changes the electrodes polarity) can be selected or optimized for a particular solvent and electrolytic mixture. Furthermore, this configuration of both carbon electrodes can be used in static mode, where the polarity is fixed and not changed.

The benefits of alternating polarity are higher graphene production rate and also enabling either or both of the electrodes to be cleaned or conditioned thereby providing a superior process. This configuration will produce more consistent and higher quality graphene along with higher yields. The applied voltage range is from 0.01 to 200 V, more preferably 1-50 V, most preferably 1-30 V.

The temperature of the electrolytic solution is less than 100° C. or more preferably less than 90° C. or most preferably below 85° C.

The process can be operated in continuous mode or in batch mode. The electrical potential can applied in several ways, such as constant voltage level throughout the duration of the process, a potential ramp to constant voltage level, a potential sweep between two voltage levels, an alternating mode with various duty cycles, or any combination of the above.

The electrolyte mixture in the electrochemical cell can be an aqueous solution, organic solvent mixture, or a mixture of organic solvent and aqueous solution containing electrolytes. This electrolyte mixture can have cations and anions of varying sizes in varying ratios. Examples of cations include Na⁺, K⁺, Li⁺, NR₄⁺ (R=solely hydrogen or solely organic moiety or mixture of hydrogen and organic moiety) or combinations thereof. Examples of anions include sulphates along with other anions of various sizes, such as Cl⁻, OH⁻, NO₃⁻, PO₄³⁻, ClO₄⁻, or mixtures thereof. The electrolyte solution can also contain radical scavengers or in-situ radical generating chemicals (e.g. (2,2,6,6-tetramethylpiperidin-1-yl) oxyl or (2,2,6,6-tetramethylpiperidin-1-yl) oxidanyl and similar materials) that can play a key role in improving and maintaining the quality of graphene.

Graphene flakes are separated from electrochemical bath using filtration, centrifugation, or decantation. Separation of graphene flakes in slurry from the top of the electrochemical bath, or bottom surface by sequential or continuous removal in a continuous fashion, makes this method especially suitable for continuous manufacturing process.

During the electrochemical process, graphene typically floats on top of the reaction media. This is fortuitous and a very useful feature as it allows the graphene being produced to be siphoned from the top of the reaction media to the next tank, making it suitable for a continuous flow process.

For production of graphene flakes in a batch process, securing carbon electrode(s) with an electrolyte permeable membrane or fastening carbon electrode(s) using a flexible electrolyte permeable membrane, such as cellulose dialysis membranes, polycarbonate membranes and muslin cloth could also be used. Such electrodes (i.e. located in an isolating membrane enclosure), after electrochemical exfoliation in an appropriate mixture of solvent and electrolyte mixture for fixed amount of time, are separated from the bath for subsequent processing of the graphene. The same electrode assembly can be sonicated in an appropriate solvent bath to produce graphene. Graphene produced by this method can be separated using filtration, centrifugation, or decantation.

Graphene particles after separation can be repeatedly cleaned with dilute acidic water, distilled/deionized water, and alcohols, such as, ethanol, methanol, isopropanol, or acetone. Wet graphene particles can be dried in air, in vacuum, in inert atmosphere, in hydrogen atmosphere, in hydrogen and argon mixed gas environment or any other mixed gas environment, by applying heat from 30-200° C. for several hours or as needed to achieve the required property.

Electrochemically produced graphene can be further post-processed using air milling, air jet milling, ball milling, rotating-blade mechanical shearing, ultrasonication, solvothermal, sonochemical, acoustic, chemical treatment, heat treatment in presence of hydrogen, inert atmospheres, vacuums, plasma treatment or a combination thereof. Chemical treatment methods include treatment of graphene particles with different reducing agents, such as sodium borohydride, hydrazine hydrate, ascorbic acid, or bubbling hydrogen gas in a suitable solvent with or without applied temperature and mechanically stirring.

Graphene is a material with a unique combination of properties with potentially very large number of applications. Many of these applications will require graphene to be tailored with a specific combination of properties. Furthermore, producing high quality and consistent graphene in appropriate quantities is critical. The electrochemical set-up and method for the production of tailored graphene materials that is suitable for both lab-scale and high volume manufacturing (HVM) has been achieved by the current invention. This method additionally produces less effluent than other methods described in prior art. This method is uniquely suited to enable tailoring and optimization of graphene properties. The following non-limiting examples are provided to describe the current invention.

### Example 1: (Preparation of Graphene Oxide—GO)

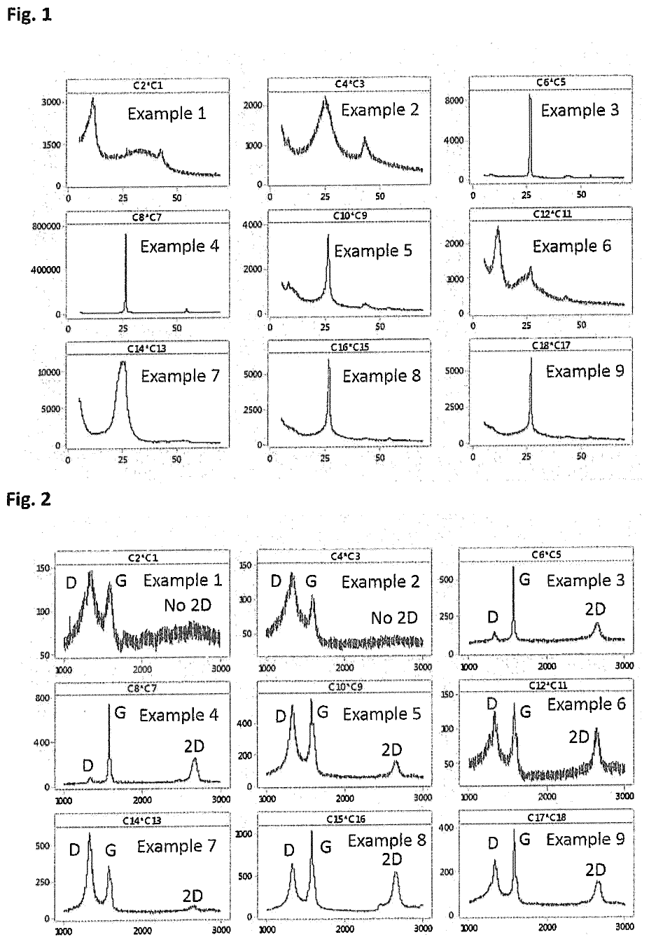

GO was prepared by using a modified Hummers' method. In a typical reaction, ˜50 ml conc. H₂SO₄ was added to ˜1 g of NaNO₃followed by stirring in an ice bath for ˜15 min. 1 g of natural graphite powder was then added to it and stirred for ˜15 min. After this step, 6.7 g KMnO₄ was added to it very slowly while stirring in an ice-bath and it was stirred for ˜30 min. The ice bath was then removed and it was then kept at 40° C. for ˜for ˜30 min. 50 ml D.I. H₂O was added to it very slowly to it while stirring. The inside temperature in the beaker increased to ˜110° C. and at that temperature it was again stirred for ˜15 min. 100 ml of warm H₂O was then added to it at last followed by 10 ml of 30 vol % H₂O₂. The reaction stopped and it was allowed to cool down to room temperature. The final product was isolated via centrifugation and washed with D.I. H₂O several times to remove all the acidic waste and other water soluble unreacted stuffs. Finally, it was washed with acetone with ˜3-4 times for drying purpose and kept in an oven at 60° C. for drying. The final product was weighed. The average yield was ˜1.5 g. Shift of (002) peak of Graphite in PXRD pattern towards lower angle around 2θ˜10-11° (FIG. 1; Example 1) clearly gives strong evidence of increase in inter-layer spacing of graphite layers. This demonstrates the formation of GO from graphite powder.

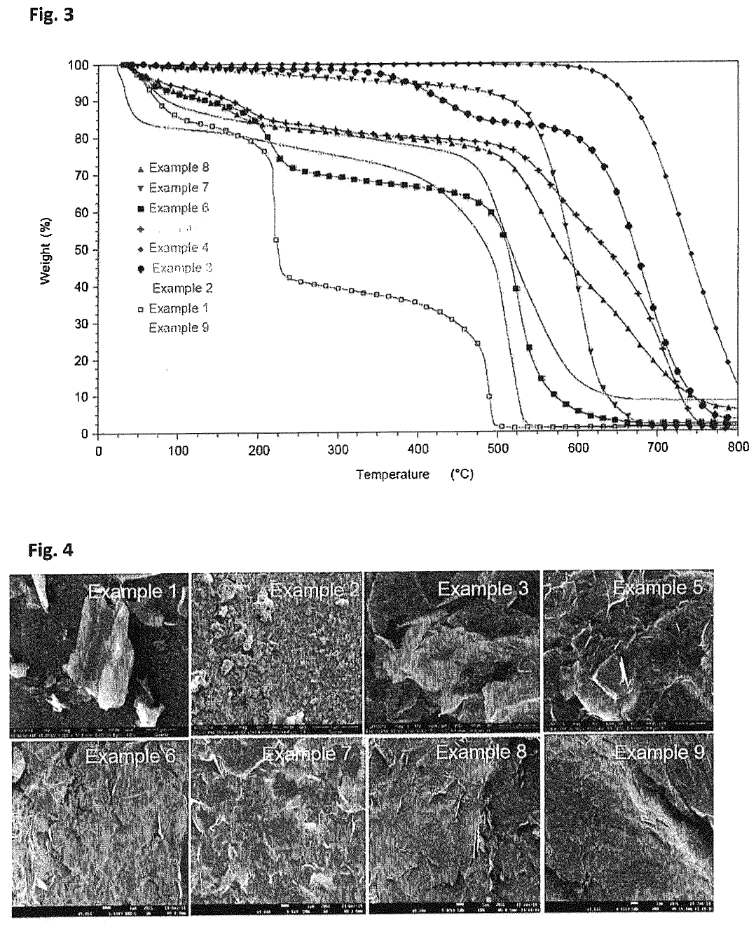

The typical Raman spectrum of example 1, as seen in FIG. 2, shows appearance of D- and G-bands with similar intensity as well as absence of 2D-band. The absence of 2D-band could be attributed to due to the presence of substantial amount of defects (functional groups) present on example 1. A typical TGA curve in air of example 1 is shown in FIG. 3. The TGA curve of example 1 shows significant weight % lost in air. Example 1 is least stable in air among all the examples. This is a clear-cut indication of having plenty of oxygen functional groups on the graphitic backbone. FIG. 4 (Example 1) shows flake morphology in micron range as evident from the SEM images.

### Example 2: (Preparation of Reduced Graphene Oxide—rGO)

In a typical reaction, 1 g of solid pre-exfoliated graphite oxide (prepared via Modified Hummers' method) was dispersed in 0.5 L of D.I. H₂O through ultra-sonication for ˜2 h. ˜0.5 ml N₂H₄·H₂O was then added to it. It was then refluxed at ˜80° C. overnight, while stirring. The color became brown to black on the next day and the final product settled down at the bottom of the flat-bottom flask. The final product was then isolated through filtration and washed several times with D.I. H₂O and then washed with acetone for drying purposes. The final supernatant pH was around ˜6 and it was then kept in an oven for final drying at ˜60° C.; weighed then. The weight of the final product was ˜0.5g. In FIG. 1 the PXRD pattern of Example 2 shows the characteristic broad peak centered around 2θ˜25° which clearly depicts removal of functional groups from the graphitic backbone (decrease in the inter-layer distance) and thereby restacking of layers in z-direction in lesser ordered fashion that in bulk graphite. The typical Raman spectrum of example 2 is shown in FIG. 2 and is almost indistinguishable with that of example 1. Thermal stability of Example 2 in air looks better than Example 1 (FIG. 3), which again signifies existence of fewer oxygen functional groups on than Example 1. FIG. 4 (Example 2) also shows micron range flakes with some agglomeration as evident from the SEM images.

### Example 3: (Commercially Available Graphene: CG-1)

Example 3 was procured from a commercial supplier, having average flake diameter of ˜15μ with 6-8 layers for our external benchmarking purpose. The PXRD pattern of example 3 given in FIG. 1, shows a sharp bulk graphitic peak centered on 2θ˜25°. This signifies the long range ordered structure along z-direction. The characteristic Raman spectrum of example 3 (FIG. 2), shows very low I_{D}/I_{G} value than the other examples, which signifies the extent of fewer defects on it. The TGA curve of example 3 (FIG. 3) shows good thermal stability in air, shows existence of a fewer number of functional groups on its' surface. FIG. 4 (Example 3) shows micron range flakes as evident from the SEM images.

### Example 4: (Commercially Available Graphite Sheet)

The graphite sheet was procured to use as an electrode for the electrochemical exfoliation method from a commercial supplier. The PXRD pattern of example 4 in FIG. 1 is almost indistinguishable of that with example 3, which signifies its' long range ordered structure along z-direction. Raman spectra of both (FIG. 2) look also similar. Thermal stability of example 4 in air is the best among all the examples, as can be seen from FIG. 3.

### General Conditions for Examples 5, 6, 8 & 9

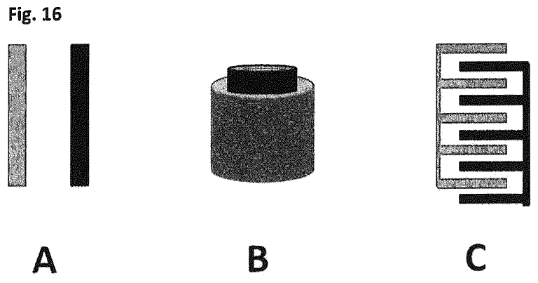

A cell was assembled having above mentioned commercially available graphite sheet as anode/working electrode (Anodic process) and Ti as cathode/counter electrode in a 1000 ml capacity acrylic polymer container having rectangular cross-section. In all the examples D.I. H₂O was used as solvent media and 10 V static potential was applied for a fixed duration, less than 24 hours, more preferably less than 12 hours, and most preferably less than 6 hours (FIG. 16). The electrolyte concentrations are kept in the range of 0.01 M to 1 M for all of these examples.

### Example 5

The electrolyte was used in this example was (NH₄)₂SO₄. After 2:30 h duration, the exfoliated product was isolated by decanting the excess solvent followed by filtration. The final product was then thoroughly washed with suitable solvents. It was then weighed and used for further characterization and analysis. The average weight of the final product is around ˜0.8 g (Table 1).

The PXRD pattern of example 5 (FIG. 1) shows a broader peak centered around 2θ˜25° than that of examples 3 and 4. This signifies lack of long-range order along z-direction in example 5 compared to examples 3 and 4. The corresponding Raman spectrum is shown in FIG. 2, which displays the characteristic D-, G- and 2D-bands. The I_{D}/I_{G} value is higher than that of example 3 which signifies the presence of a greater number of defects than example 3. Thermal stability of example 5 in air is also less than that of example 3 as can be seen from TGA curve in FIG. 3. This corresponds to the existence of a greater number of functional groups on the graphene surface than example 3. Micron range flakes, which are thinner than the other examples, were evident from the SEM images (FIG. 4).

### Example 6

The electrolyte used in this example was a mixture of (NH₄)₂SO₄ and NaNO₃. After a 2:30 h duration, the exfoliated product was isolated by decanting the excess solvent followed by filtration. The final product was then thoroughly washed with suitable solvents. It was then weighed and used for further characterization and analysis. The average weight of the final product is around ˜2.2 g (Table 1).

In FIG. 1, the PXRD pattern of example 6 shows a broad peak around 2θ˜12° and another broad, less intense peak, centered around 2θ˜25°. Interestingly, this pattern looks similar that of example 1, which signifies an increase in inter-layer spacing of graphite layers through insertion of oxygen functional groups on edges/basal plane through this anodic electrochemical exfoliation process.

The corresponding Raman spectrum is shown in FIG. 2, which shows the appearance of the characteristic D-, G- and 2D-bands. In this case, intensity of the 2D band is a little higher than example 5. In this example, the I_{D}/I_{G} value is also higher than that of example 3 and the same justification is applicable here as in example 5. Thermal stability of example 6 in air is lower than that of example 5, as can be seen from FIG. 3. This signifies the existence of an even higher number of functional groups on the graphene surface than example 5. Micron range flakes were evident from the SEM images (FIG. 4).

### Example 7

This sample was obtained from example 6 and was added to D.I. H₂O and then stirred for ˜10 min for proper mixing. Then N₂H₄·H₂O was added to it and refluxed with stirring ˜55° C. for ˜18 h. The final product was then thoroughly washed with suitable solvents. It was then weighed and used for further characterization and analysis. The average weight of the final product is ˜0.4 g.

In FIG. 1, the PXRD pattern of example 7 shows an absence of a peak around 2θ˜12° as well as a broader peak centered around 2θ˜25° compared to example 5 which signifies removal of oxygen containing functional groups from the surface of example 6 after hydrazine treatment and lack of long range order in comparison to example 5. This may be attributed to either creation of smaller graphene flakes or generation of a more exfoliated sample than example 5.

The Raman spectrum of example 7 is shown in FIG. 2. I_{G}/I_{D} and I_{2D}/I_{G} values are less than that of example 6. Interestingly noted, the thermal stability of example 7 in air is the second best after the graphite sheet, and much better than that of examples 5 and 6 (FIG. 3). This is definitely an indirect indication of removal of residual functional groups from the graphitic backbone during hydrazine treatment. Micron range thin flakes were evident from the SEM images (FIG. 4).

### Example 8

The electrolyte used in this example was a mixture of (NH₄)₂SO₄ and Na₃PO₄·10H₂O. After 2:30 h, the exfoliated product was isolated by decanting the excess solvent and followed by filtration. It was then thoroughly washed with suitable solvents. It was then weighed and used for further characterization and analysis. The average weight of the final product is around ˜1.0 g (Table 1).

The PXRD pattern of example 8 (FIG. 1) shows a broader peak centered around 2θ˜25° which signifies lack of long-range order along z-direction as in example 5. The corresponding Raman spectrum in FIG. 2 shows the appearance of characteristic D-, G- and 2D-bands. The I_{D}/I_{G} value is lower than that of examples 5-7 which signifies the extent of fewer defects present. Thermal stability of example 8 in air is similar with that of example 5 as can be seen from TGA curve in FIG. 3. Micron range flakes were observed from the SEM images (FIG. 4).

### Example 9

The electrolyte used in this example only contains Na₃PO₄·10H₂O. After 2:30 h, the final product was isolated by decanting the excess solvent and followed by filtration. It was then thoroughly washed with suitable solvents. It was then weighed and used for further characterization and analysis. The average weight of the final product is around ˜0.5 g (Table 1).

Lack of long-range order along z-direction in example 9 was evident from the PXRD pattern as seen in FIG. 1. The lower I_{D}/I_{G} value from the Raman spectrum (FIG. 2) signifies the extent of fewer defects compared to examples 5-7. Thermal stability of example 9 in air is similar with that of examples 5 and 8 as can be seen from TGA curve in FIG. 3. Micron range flakes were observed in the SEM images (FIG. 4).

### Examples 10-15: Varying Ratios of Multiple (Binary) Exfoliating Ions

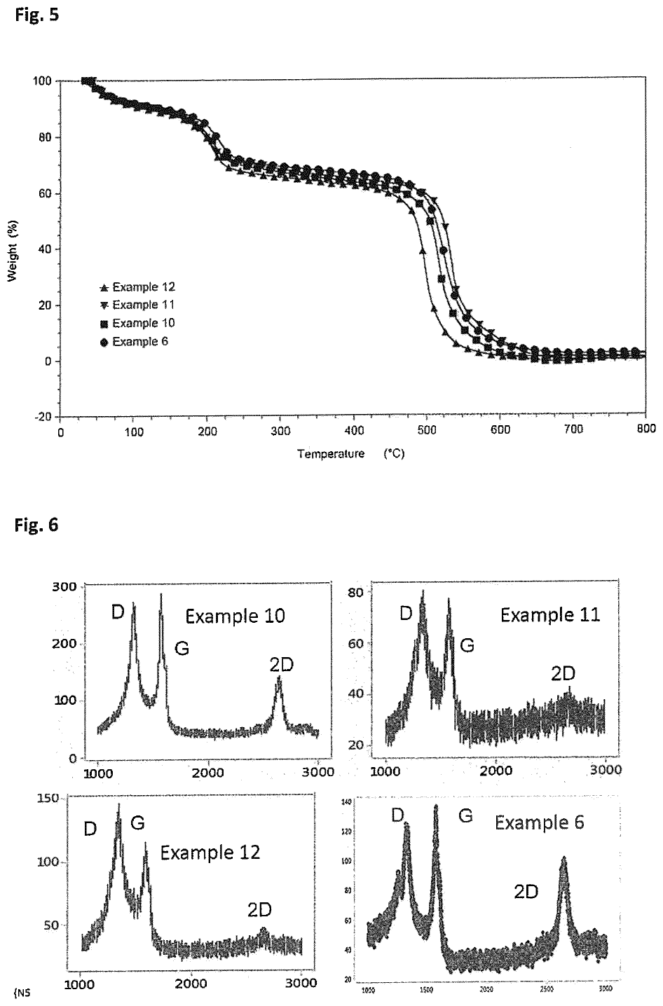

The effects of varying ratios of multiple exfoliating ions on the characteristics of final graphene materials have been demonstrated in this disclosure. The corresponding samples have been named as example 6 and 10-12 respectively for the case when, exfoliating ions are (NH₄)₂SO₄ and NaNO₃. Corresponding TGA curves in air as well as from Raman spectra are shown in FIGS. 5 and 6. These results show that the characteristics of the final graphene materials can be engineered by this unique strategy.

The kinetics of the exfoliation process are highly dependent on the nature and the varying ratio of multiple exfoliating ions. This phenomenon is reflected by the variation in yield of the graphene materials produced under similar processing condition as can be seen in Table 1. For comparison, examples 13-15 show very kinetically sluggish processes, when non appropriate mixtures of exfoliating ions are used.

### Examples 16 & 17: Varying Ratios of Multiple (Ternary) Exfoliating Ions

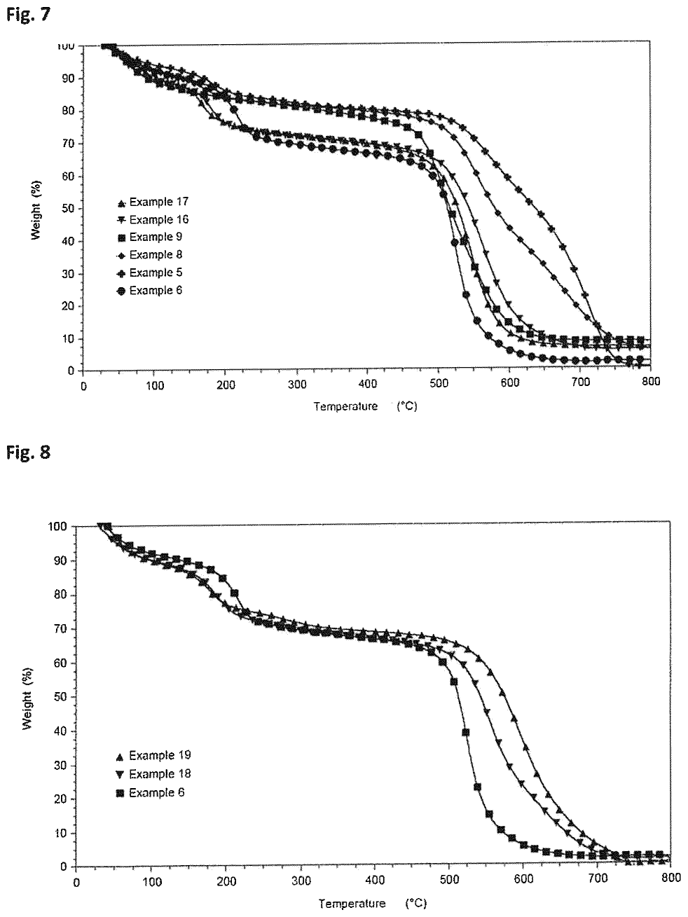

Ternary mixtures of multiple exfoliating ions have been used for the production of graphene materials as demonstrated in this disclosure. The corresponding samples have been described in examples 16 and 17. The details of these processes have been given in Table 1. The characteristics of these final graphene materials could be engineered by this strategy which is evident from corresponding comparative TGA curves in air (FIG. 7).

### Examples 18 & 19: Effect of Stepwise Exfoliation Using Multiple Exfoliating Ions

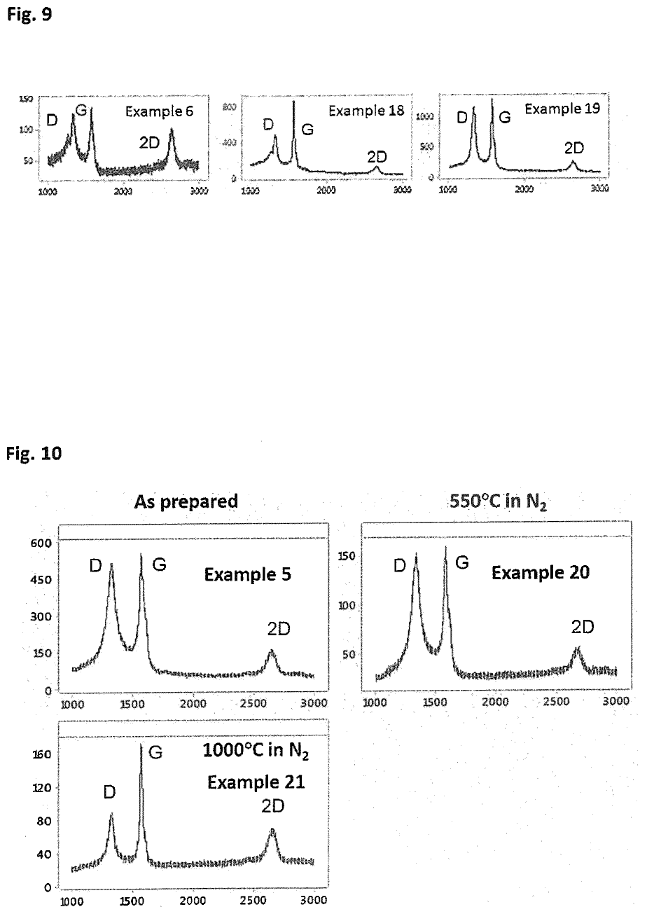

Stepwise exfoliation using multiple exfoliating ions have been used for the production of graphene materials as demonstrated in this disclosure. The corresponding samples have been described in examples 18 and 19. The details of these processes have been given in Table 1. The characteristics of these final graphene materials can be engineered by this method which is also evident from corresponding comparative TGA curves in air and from the Raman spectra shown in FIGS. 8 and 9.

### Examples 20 & 21

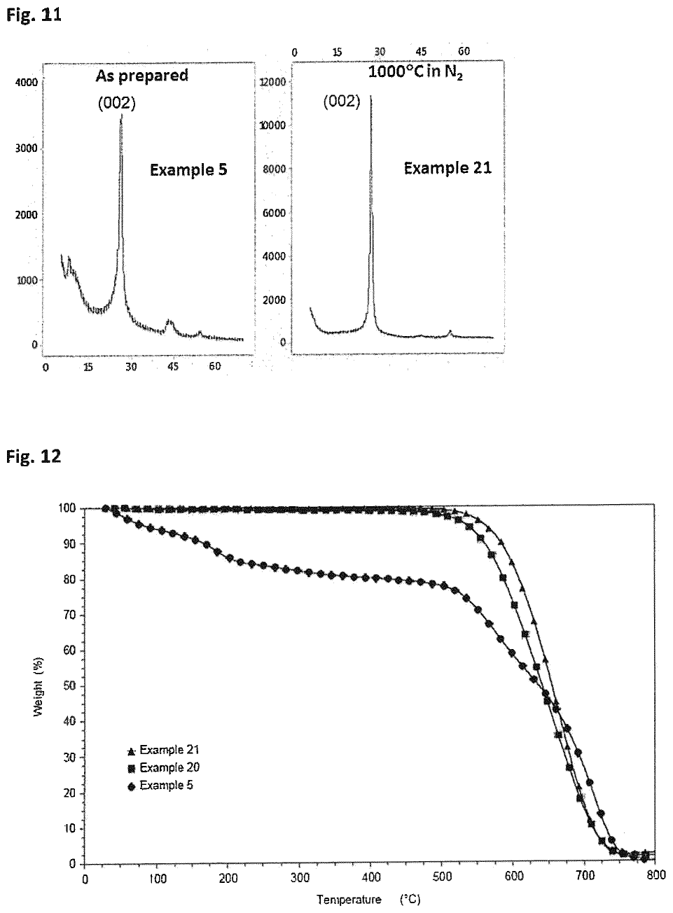

Different graphene materials can be produced by post heat treatment of the as prepared graphene materials. To demonstrate the effect of post heat treatment, the sample produced in example 5 was heat treated at 550° C. and 1000° C., respectively, in N₂ environment. The corresponding samples have been named examples 20 and 21 respectively. The characteristics of these final graphene materials can be engineered by this approach which is evident from corresponding comparative Raman spectra, PXRD and TGA curves in air, as shown in FIGS. 10-12 respectively.

### Example 22

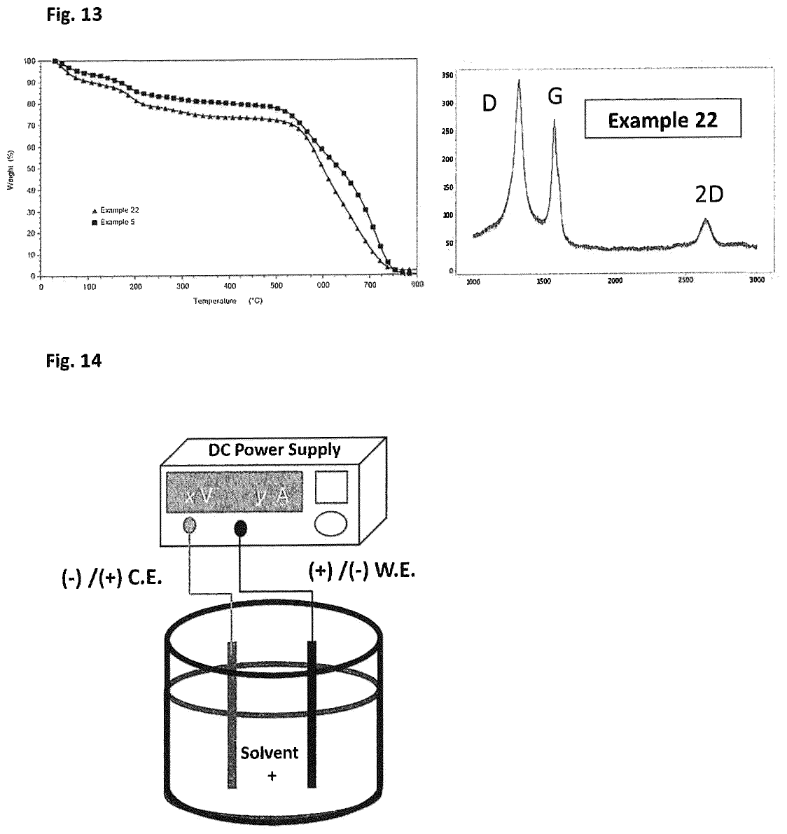

(2,2,6,6-tetramethylpiperidin-1-yl) oxyl or (2,2,6,6-tetramethylpiperidin-1-yl) oxidanyl, (commonly known as TEMPO), has been utilized as a radical scavengaer to see the effect on the quality of final graphene material and has been presented in this disclosure. The corresponding sample has been described as Example 22 as seen in Table 1. Comparative TGA curves in air of Examples 5 and 22, as well as Raman spectrum of Example 22 sample are shown in FIG. 13.

TABLE 1

| Sample | | Weight of the final |
|---|---|---|
| Name | Exfoliating Ions | product |
| Example-5 | (NH₄)₂SO₄ | ~0.8 g |
| Example-6 | (NH₄)₂SO₄NaNO₃ (1:1) | ~2.2 g |
| Example-8 | (NH₄)₂SO₄ and Na₃PO₄•10H₂O (1:1) | ~1.0 g |
| Example-9 | Na₃PO₄•10H₂O | ~0.5 g |
| Example-10 | (NH₄)₂SO₄ and NaNO₃ (0.5:0.5) | ~0.4 g |
| Example-11 | (NH₄)₂SO₄ and NaNO₃ (1:0.5) | ~1.3 g |
| Example-12 | (NH₄)₂SO₄NaNO₃ (0.5:1) | ~0.7 g |
| Example-13 | (NH₄)₂SO₄ and KOH (1:1) | ~0.3 g |
| Example-14 | NaClO₄ | ~0.06 g |
| Example-15 | NaNO₃ | ~0.4 g |
| Example-16 | (NH₄)₂SO₄; Na₃PO₄•10H₂O and NaNO₃ (1:0.8:0.2) | ~1.8 g |
| Example-17 | (NH₄)₂SO₄; Na₃PO₄•10H₂O and) NaNO₃ (0.8:1:0.2) | ~1.5 g |
| Example-18 | Anodic intercalation in an electrolytic solution containing | ~1.1 g |
| | NaNO₃ at 10 V for ~30 min followed by anodic intercalation | |
| | applying a static potential of 10 V in electrolytic solution | |
| | containing (NH₄)₂SO₄ for ~2.30 h | |
| Example-19 | Anodic intercalation followed by cathodic de-intercalation | ~0.6 g |
| | in an electrolytic solution containing NaNO₃ at 10 V for ~30 | |
| | min, respectively; followed by anodic intercalation applying | |
| | a static potential of 10 V in electrolytic solution containing | |
| | (NH₄)₂SO₄ for ~2.30 h | |
| Example-22 | (NH₄)₂SO₄ along with TEMPO | ~0.5 g |

1. A method of making high quality graphene comprising the steps of:
a. providing an electrochemical cell, wherein the electrochemical cell comprises:
i. one or more working electrodes;
ii. one or more counter electrodes; and
iii. an aqueous electrolyte comprising one or more exfoliating ions;
b. exfoliating the working electrode to produce high quality graphene;
wherein the high quality graphene has characteristics that are engineered for targeted applications.

2. The method of claim 1, wherein the one or more exfoliating ions is selected from the group consisting of Na⁺, K⁺, Li⁺, NR₄⁺, wherein R=hydrogen, organic moiety or a mixture of hydrogen and organic moiety, SO₄²⁻, Cl⁻, OH⁻, NO₃⁻, PO₄³⁻, ClO₄⁻, and combinations thereof.

3. The method according to claim 1, wherein the one or more exfoliating ions comprises two or more exfoliating ions, wherein the two or more exfoliating ions are used simultaneously. cm 4. The method according to claim 1, wherein one or more exfoliating ions comprises two or more exfoliating ions, wherein the two or more exfoliating ions are used step wise, one exfoliating ion followed by another exfoliating ion.

5. The method according to claim 1, wherein the aqueous electrolyte has a temperature of less than 100° C.

6. The method according to claim 5, wherein the aqueous electrolyte has a temperature of less than 90° C.

7. The method according to claim 6, wherein the aqueous electrolyte is ambient temperature.

8. The method according to claim 1, wherein the one or more working electrodes comprises pyrolytic graphite, natural graphite, synthetic graphite, intercalated carbon materials, carbon fiber, carbon flakes, carbon platelets, carbon particles, or combinations thereof.

9. The method according to claim 1, wherein the one or more working electrodes is produced from carbon powder or flakes compressed together to form sheets, rods, pellets, or combinations thereof.

10. The method according to claim 8, wherein the one or more working electrodes is pretreated by electrochemical treatment, thermal treatment, sonication treatment, plasma treatment, air or vacuum treatment and combinations thereof.

11. The method according to claim 1, wherein the one or more counter electrodes comprises an inert conducting metal, nonmetal conductor, and combinations thereof.

12. The method according to claim 11, wherein the one or more counter electrodes comprises platinum, titanium, high quality steel, aluminum, graphite, or glassy carbon.

13. The method according to claim 1, wherein a voltage from 0.01-200 V is applied to the aqueous electrolyte.

14. The method according to claim 13, wherein a voltage from 1-50 V is applied to the aqueous electrolyte.

15. The method according to claim 14, wherein a voltage from 1-30 V is applied to the aqueous electrolyte.

16. The method according to claim 1, wherein the aqueous electrolyte is not acidic.

17. The method according to claim 1, wherein the engineered characteristics of the graphene comprise size, aspect ratio, edge definition, surface functionalization, number of layers and combinations thereof.

18. The method according to claim 1, wherein the graphene is continuously removed from the electrolytic cell and continuously manufactured.

19. The method according to claim 13, wherein the voltage applied is of alternating polarity.

20. The method according to claim 19, wherein the alternating polarity is specified by duty cycle or is ramped.

21. The method according to claim 1, wherein the one or more working electrodes is located in an isolated membrane enclosure or bag.

22. An electrochemical cell for making graphene flakes comprising:
a. a graphene producing working electrode;
b. a counter electrode; and
c. an aqueous electrolyte comprising one or more exfoliating ions;
wherein high volume and high quality graphene is produced.

23. The electrochemical cell according to claim 22, wherein the one or more exfoliating ions is selected from the group consisting of Na⁺, K⁺, Li⁺, NR₄⁺, wherein R=hydrogen, organic moiety or a mixture of hydrogen and organic moiety, SO₄²⁻, Cl⁻, OH⁻, NO₃⁻, PO₄³⁻, ClO₄⁻, and combinations thereof.

24. The electrochemical cell according to claim 22, wherein the working electrode comprises pyrolytic graphite, natural graphite, synthetic graphite, intercalated carbon materials, carbon fiber, carbon flakes, carbon platelets, carbon particles, or combinations thereof.

25. The electrochemical cell according to claim 24, wherein the working electrode is pretreated by electrochemical treatment, thermal treatment, sonication treatment, plasma treatment, air or vacuum treatment and combinations thereof.

26. The electrochemical cell according to claim 22, wherein the counter electrode comprises an inert conducting metal, nonmetal conductor, and combinations thereof.

27. The electrochemical cell according to claim 26, wherein the counter electrode comprises platinum, titanium high quality steel, aluminum, graphite or glassy carbon.

28. The electrochemical cell according to claim 22, wherein a voltage from 0.01-200 V is applied.

29. The electrochemical cell according to claim 28, wherein a voltage from 1-50 V is applied.

30. The electrochemical cell according to claim 29, wherein a voltage from 1-30 V is applied.

31. The electrochemical cell according to claim 22, wherein the aqueous electrolyte has a temperature of less than 100° C.

32. The electrochemical cell according to claim 31, wherein the aqueous electrolyte has a temperature of less than 90° C.

33. The electrochemical cell according to claim 28, wherein the voltage applied is of alternating polarity.

34. The electrochemical cell according to claim 33, wherein the alternating polarity is specified by duty cycle or is ramped.

35. The electrochemical cell according to claim 22, wherein the working electrode is located in an isolated membrane enclosure or bag.
